(19) United States
(12) Patent Application Publication
(10) Pub. No.: US 2024/0166416 A1
(43) Pub. Date: May 23, 2024

(54) REMOTE CONTROL PACKAGING AND A METHOD OF MANUFACTURING SUCH PACKAGING

(71) Applicant: FM MARKETING GMBH, Neumarkt am Wallersee (AT)

(72) Inventor: Ferdinand MAIER, Neumarkt am Wallersee (AT)

(21) Appl. No.: 18/274,758

(22) PCT Filed: Feb. 3, 2022
(86) PCT No.: PCT/IB2022/050954

§ 371 Date: Jul. 28, 2023

(30) Foreign Application Priority Data
Feb. 3, 2021 (DE) 10 2021 102 528.1

(51) Int. Cl. B65D 65/46

(52) U.S. Cl. CPC B65D 65/466; B65D 2585/6835

(57) ABSTRACT

A remote control packaging (10) made of a folded material of a sheet (1) comprising a closed packaging interior in which a remote control is arranged and a plurality of walls defining the packaging interior, wherein the walls of the remote control packaging (10) are formed in multiple layers with a foil inner layer (8) of poly(1,4-butylene succinate) and a paper outer layer (9) for mechanical stabilisation thereof.

### CROSS-REFERENCE TO RELATED APPLICATIONS

This Application is a national stage application of PCT/IB2022/050954. This application claims priorities from PCT Application No. PCT/IB2022/050954, filed Feb. 3, 2022, and from the German patent application 10 2021 102 528.1 filed Feb. 3, 2021, the content of which are incorporated herein in the entirety by reference.

### TECHNICAL FIELD

The present application relates to a remote control packaging in the shape of a bag according to the preamble of claim 1 and a method of manufacturing such packaging.

### BACKGROUND

In the field of remote control packaging, the expert distinguishes between packaging boxes and bags.

Packaging in the shape of packaging boxes made of composite materials comprising foil layers and paper layers is known from JP 2004-67 192 A, DE 10 2018 132 689 A, JP 2007-145 396 A and JP 3 077 714 U. In contrast to bags, there is usually only a slight risk of scratching for boxes. For a bag, the risk of scratching and the associated contact pressure is increased, especially in the area of the folded edges, due to the large contact areas of the inner wall on both sides of the remote control. Contrarily, compared to a packaging box, the bag takes up less space and the movement of the remote control in the bag is inhibited by the contact pressure. At the same time, the bag has a certain amount of play so that the remote controls to be packed can be of different dimensions within a certain tolerance range. The remote control is thus not free to move in the bag, unlike in the box, and does not have to be inhibited by additional means, such as box inserts which are adapted to the specific contour of the remote control, and can thus be used more universally.

JP 2005001703 A discloses in FIGS. 1-10 a bag with a multi-part wall. A rectangular stiffening element is embedded in the centre of the packaging, which together with a frame forms a composite container in the shape of a box. In this case, the combination of frame and bag forms the packaging.

Paper and/or foil packaging is also known from the current state of the art. The disadvantage of paper packaging in the field of remote controls is that they are typically delivered with batteries.

The disadvantage of foil packaging, such as U.S. Pat. No. 6,817,470B1, is on the one hand the poor printability and on the other hand the insufficient mechanical protection. A material composite is also problematic when recycling the material.

The surface of pure paper layers, however, is too rough, so that there is a risk that a remote control placed inside will be scratched on the inside of the bag.

### SUMMARY

Based on this state of the art, the present invention solves this problem by a remote control packaging having the features of claim 1 and a method having the features of claim 15.

A remote control packaging according to the invention is designed as a bag. This is also known among experts as a flat bag. The bag is shaped from a folded material of a sheet. The bag comprises a closed packaging interior in which a remote control is arranged or can be arranged.

Furthermore, the remote control packaging comprises several walls delimiting the interior of the packaging. These are shaped in particular from the material of the sheet.

The walls of the bag are preferably made of several layers. They comprise at least one foil inner layer which is essentially, i.e. more than 80 wt %, made of poly(1,4-butylene succinate). Furthermore, they comprise a paper outer layer for mechanical stabilisation of said foil inner layer.

Due to its material differences, PBS in particular has a significantly higher compressive stress level compared to a large number of comparable plastics in the foil sector, such as polypropylene and polybutylene. Therefore, it is ideal for the aforementioned application when it is used as a foil inner layer.

The disadvantage, however, is that material changes occur when stored in direct sunlight. UV radiation and/or heat input can lead to material changes in the foil material. Here, the paper outer layer not only supports mechanical stability, but also serves as material protection against environmental influences.

This simple but at the same time very effective measure enables a multitude of advantages, which are particularly effective in the packaging of battery-operated remote controls.

Further advantages are among others the subject of the dependent claims and the following description pages.

It is advantageous if the materials of the foil inner layer and the paper outer layer are designed as layers that are joined together to form a wall, whereby the wall of the bag is preferably only designed to have two layers.

This also means that the foil inner layer is directly adjacent to the paper outer layer.

The wall can preferably be realised in an injection moulding process, in which the foil layer is applied to the paper layer.

For additional improved recyclability, the remote control packaging in the shape of a bag consists of at least 80 wt %, preferably at least 90 wt %, particularly preferably 95 wt %, of paper.

Furthermore, for the same reasons, the remote control packaging may consist of less than 20 wt % of the foil inner layer.

The paper outer layer can cover the entire surface of the foil inner layer to protect it from direct sunlight.

Furthermore, the foil inner layer can have an antistatic agent as ESD protection. Preferably, it can be a dissipative ESD material.

The bag may be folded from a sheet and glued via adhesive flaps, the remote control packaging having a wearable insertion opening for insertion of a product. The insertion opening can preferably be closed by folding over a flap and bonding the folded-over flap with a label.

Furthermore, the remote control packaging may have a predetermined tear point or a predetermined separation point, preferably in the region of the insertion opening.

To avoid weakening of the material, the remote control packaging can have rebated and/or folded edges which are designed as grooves.

Furthermore according to the invention, a method of manufacturing a remote control packaging according to the invention in the shape of a bag comprises at least the following steps:
a Providing the paper outer layer;
b Applying the foil inner layer to form a multilayer, in particular two-layer, sheet as a paper-plastic wall;
c Inserting rebated and/or folded lines in the sheet and/or
d Shaping the packaging;
e Bonding the packaging with shaping of the bag;
f Inserting the remote control into the packaging and closing the insertion opening, in particular by welding and/or heat sealing.

Further advantages, features and details of the invention will be apparent from the following description, in which an embodiment example of the invention is explained in more detail with reference to the accompanying drawings. For the expert it is advisable to consider the features disclosed in combination in the drawing, the description and the claims also individually and combine them to form useful further combinations. In particular, there are numerous options in which the subject matter of the embodiment example can be modified.

### BRIEF DESCRIPTION OF THE DRAWINGS

FIG. 1A shows an open view of a sheet of a remote control packaging according to the invention;

FIG. 1B shows a schematic sectional view of a wall of the sheet of FIG. 1A and

FIG. 2 shows the sheet folded into a remote control packaging.

### REFERENCE SIGNS

1 Sheet
2 Rebated or folded edges
3 Middle segment
4 Secondary segment
5 Secondary segment
6 Adhesive flap
7 Adhesive flap
8 Foil inner layer
9 Outer layer
10 Remote control packaging/bag
11 Reverse
12 Adhesive seam
13 Insertion opening

### DETAILED DESCRIPTION

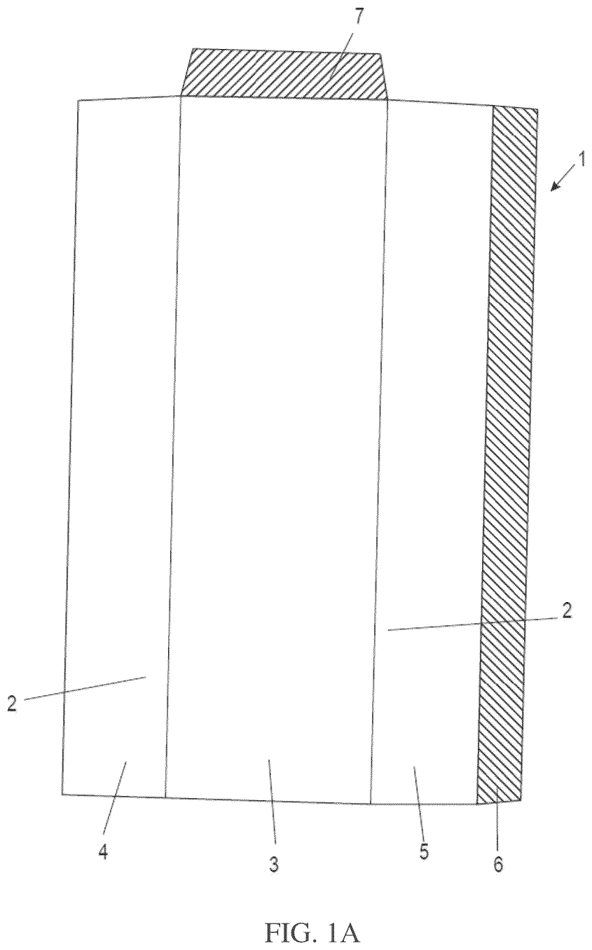

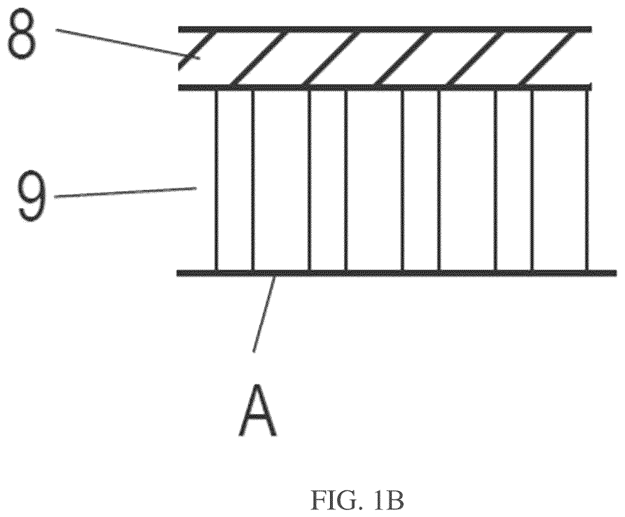

The following description first defines an exemplary and preferred structure of a remote control packaging 10. FIG. 1 shows a sheet with a length and a width. Here, as a convention of a better objective description, it is assumed that the extension in the longitudinal direction and a length of the sheet are always greater than the extension of the sheet in its width. The same applies to the shaped packaging 10.

FIG. 1A shows a sheet 1 with two rebated or folded edges 2 running parallel in the longitudinal direction of the packaging and a middle segment 3 arranged between the rebated or folded edges 2, which corresponds to the remote control packaging 10 in length and width.

On either side of the rebated or folded edges 2 and adjacent to the middle segment 3 are two secondary segments 4 and 5 which are narrower in width and identical in length. An adhesive flap 6 with an adhesive agent extending over the entire length of the edge of the secondary segment 5 is arranged adjacent to one of the secondary segments 5.

In the longitudinal direction, an adhesive flap 7 is also arranged at the edge of the middle segment 3, which extends over the entire width of the edge of the middle segment 3. A rebated or folded edge is arranged between the adhesive flap 7 and the middle segment 3.

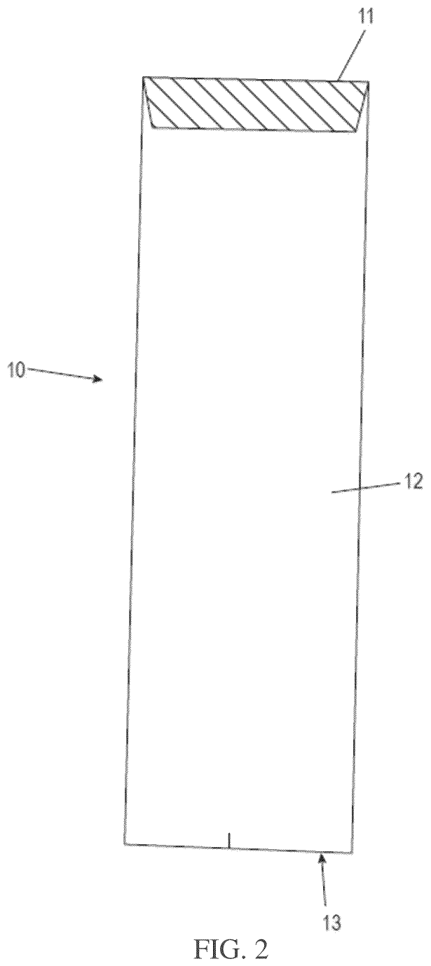

FIG. 2 shows a folded remote control packaging 10 in the shape of a bag, commonly also referred to as flat bag, with a closed reverse 11, an adhesive seam 12 in the longitudinal direction of the packaging 10 and an insertion opening 13 for inserting a remote control into the packaging 10. The folding is done in such a way that two layers at the rebated or folded edge 2 define an acute angle, preferably of less than 45°. This makes it possible to minimise the space required by the packaged electronic article.

The sheet 1 is preferably designed in two or more layers, as can be seen in FIG. 1B, whereby an foil inner layer 8 for delimiting the packaging interior I is directly attached to an outer layer 9 with an outer side A, which is exposed to environmental influences such as moisture, dirt and the like.

In unfavourable storage conditions or during longer storage, battery fluid or battery gel may leak out. It is therefore advisable that the foil inner layer completely encloses or covers the interior of the packaging, which protects the outer layer from the packaged goods.

Poly (1,4-butylene succinate)—in short PBS—is recommended as the foil inner layer 8. PBS foils are both extrudable and stretchable and can be processed into foil in the same way as PP (polypropylene) or PB (polybutylene) without any production-related problems. The tensile strength and flexural modulus are comparable to polypropylene or polybutylene. In contrast to the aforementioned foils, PBS is a biodegradable plastic. This can be done, for example, with the help of fungi or bacteria in the course of composting. Another difference to conventional plastic foils, such as PP and PB, is the increased thermal expansion rate at low temperatures. This means that the foil can also be used as wall material with layers, which also have a high thermal expansion rate, without tearing in the transition area of the layers.

In addition, however, due to its very small crystalline superstructure compared to PP and PB, PBS has a higher compressive stress level, which affects the flexibility of the foil and its tear strength. As a result, a smaller foil thickness can be realised than with conventional foils, which has advantages when folded into a packaging.

For example, thicker foils can develop much higher restoring forces at the rebated or folded lines, which makes folding more difficult. This in turn means that higher forces have to be applied during folding, which leads to a change in the material in the folding area and thus to a leakage point with higher diffusion values in the folding area. This is prevented by a correspondingly thin and at the same time flexible and tear-resistant PBS inner layer.

In addition, PBS has a significantly higher tear strength of approx. 38 MPa at room temperature than PP or PB, so that the packaged remote control is better protected against unintentional tearing or puncturing of the packaging.

The preferred average layer thickness of the foil inner layer 8 for optimum mechanical protection and tear resistance may be at least 5 μm, preferably 8-30 μm.

PBS foil material should not be exposed to direct sunlight or high temperatures of more than 100° C. Therefore, the sheet has a light-protective outer layer 9 on the foil material. A paper layer is used for this purpose.

The paper outer layer can have a preferred grammage or surface weight of more than 80 g/m2, particularly preferably between 90-135 g/m2 and especially 105-125 g/m2. The paper outer layer stabilises the flexible foil inner layer.

The average thickness of the paper outer layer may be between 60-250 μm, preferably between 100-180 μm and particularly preferred between 120-160 μm. The latter range represents a good optimum for shaping the packaging, especially in combination with the foil inner layer.

The aforementioned layer thicknesses of the foil inner layer and the paper outer layer have been described as average layer thicknesses. Since paper consists of fibrous material, the material surface is not uniform and smooth, but similar to a fibre mat. Therefore, a representative average value for the thickness or layer thickness must be formed from several measurements, e.g. 20 measurements at different locations. Corresponding to the base of the paper layer, the foil inner layer also has unevenness and uneven distribution, which is why averaging the layer thickness is necessary.

Particularly preferred is an embodiment with an outer paper layer 9 being thicker than the foil inner layer, preferably at least twice as thick, particularly preferred at least 4 times as thick.

The combination of inner layer 8 and outer layer 9 is preferably formed as a paper-foil wall, with an area-wise, or particularly preferred full-surface, material bond between the inner layer and the outer layer. The material bond is preferably achieved without the addition of an additional adhesive, i.e. by a fusion or welded joint. In this way, the freshly extruded and/or melt-blown foil can be deposited on the outer layer in a slightly tacky state during the manufacturing process before it is completely cured, thereby forming a material bond with the outer layer.

Since gases can be released in the remote control packaging due to electrochemical reactions, e.g. by the batteries, the packaging should have particularly good bursting strength.

Therefore, it is recommended to use a paper layer with a bursting strength according to DIN EN ISO 2758 of at least 300 kPa (kiloPascal), especially between 350-550 kPa.

The use of PBS with its optimised compressive stress level additionally contributes to a particularly good bursting strength of the paper-foil wall and is therefore optimised for the protection of devices comprising a battery.

To reduce sunlight, the recommended colour for the paper layer is “white” in one of the RAL colours 9003, 9010 or 9016. A layer of recycled paper is recommended for the paper layer.

Particularly preferred, the PBS material can be obtained from native raw materials in order to further optimise the ecological footprint of the packaging.

The outer layer can be printed. In this process, the sheet can be printed with a graphic and/or a label in the area of the middle segment 3, for example, before it is shaped into a packaging. This sheet, also referred to as an imposition, can be loaded into a conventional printing machine.

In contrast to a foil substrate, the ink adheres to a paper substrate over a long period of time, as the ink flows better on paper and partially penetrates the fibre material of the paper.

It is further advantageous if the rebated and/or folded edges 2 are formed as grooves instead of slots. For this purpose, the rebated and/or folded edge 2 of the foil-paper wall is pressed in with a tool with a rounded end face while being shaped out of the paper plane. The inclusion of the grooves further reduces the risk of material softening, material displacement or material weakening of the foil material at the bent edges. This allows liquids or protective gas, for example, to remain reliably in the packaging.

In a further embodiment of the invention, the foil material can have an antistatic agent (based on EN 61340-5-3) which changes the material properties of the foil in such a way that it is electrically conductive or dissipative. Antistatic agents are currently incorporated into mostly pink ESD foil bags in the electronic sector. It has surprisingly been shown that antistatic agents can also be incorporated into the PBS material of the foil inner layer, despite a different crystalline superstructure to that of PP or PB, so that additional ESD protection is possible.

The foil inner layer is preferably designed as a smooth foil layer to protect against scratches and unintentional tearing. However, it is also possible to design the foil inner layer as a bubble wrap, which gives the remote control packaging additional stability against mechanical shock. In most cases, remote controls have individual elements of transmitter and receiver modules in exposed positions. Here, the bubble wrap made of PBS material offers additional protection against slipping of the elements inside the remote control in case of shocks, e.g. during transport.

The foil inner layer 8 is considerably more resistant to tearing when oblique forces are applied than the paper outer layer 9. In a preferred embodiment, a predetermined tear point or a predetermined separation point can be provided, in which, for example, a pre-embossing of the foil is provided or in which a welding or adhesive web with lower tearing forces than the foil itself is provided.

Preferably, in addition to the bonding by means of the adhesive flaps, the foil inner layer is bonded in an opening area or, particularly preferably, welded, especially welded in an airtight manner or heat-sealed.

A viewing window can be left out of the wall in the paper layer, which makes the batteries, in particular shrink-wrapped batteries, of a packaged remote control, which are arranged in this area, visible to the consumer. The viewing window can be formed only from the foil layer and be transparent.

The viewing window can be formed as a punched hole and have a viewing window made of transparent plastic material, which merges into the foil layer at the edge. The transparent plastic material arranged in the viewing window can partially comprise the material of the foil layer or be formed entirely from this material.

As can be seen from FIG. 2, the packaging interior of the bag is essentially defined by two opposite walls, the walls being immediately adjacent apart from the folded edges.

The two secondary segments 4 and 5 form the first of the walls and the middle segment 3 the second of the walls.

The two opposite walls are directly connected to each other via the rebated edges 2.

From FIG. 2 and the aforementioned description of the manufacture of the bag, it can be seen that the interior of the packaging is preferably delimited on all sides and throughout exclusively by the foil inner layer 8 and is closed in the packaged state with the remote control or in the closed state.

1. Remote control packaging (10) in the shape of a bag made of a folded material of a sheet (1) comprising a closed package interior in which a remote control is arranged and a plurality of walls bounding the package interior, wherein the walls of the bag (10) are constructed in multiple layers with a foil inner layer (8) of poly(1,4-butylene succinate) and a paper outer layer (9) for mechanical stabilisation thereof.

2. The remote control packaging according to claim 1, wherein the foil inner layer (8) and the paper outer layer (9) are firmly bonded and designed as layers to form one of the walls.

3. The remote control packaging according to claim 1, wherein the walls of the remote control packaging (10) are preferably only formed with two layers.

4. The remote control packaging as claimed in claim 1, wherein the remote control packaging consists of at least 80 wt % of paper.

5. The remote control packaging as claimed in claim 1, wherein the remote control packaging consists of less than 20 wt % of foil inner layer (8).

6. The remote control packaging as claimed in claim 1, wherein the foil inner layer (8) features an antistatic agent as ESD protection.

7. The remote control packaging as claimed in claim 1, wherein the bag (10) is folded from a sheet (1) and bonded via one or more adhesive flaps (6, 7), the remote control packaging (10) having a closable insertion opening (13) for insertion of a remote control.

8. The remote control packaging as claimed in claim 1, wherein the bag (10) features, preferably in the region of the insertion opening (13), a predetermined tear point or a predetermined separation point.

9. The remote control packaging as claimed in claim 1, wherein the bag (10) features a plurality of rebated and/or folded edges (2) which are formed as grooves.

10. The remote control packaging as claimed in claim 1, wherein the paper outer layer (9) has an average layer thickness between 60-250 μm, preferably between 100-180 μm and particularly preferred between 120-160 μm and/or a bursting strength of at least 300 kPa (kiloPascal).

11. The remote control packaging as claimed in claim 1, wherein the packaging interior of the bag is delimited by only two opposite walls which are preferably directly connected to each other via the folded edges (2).

12. The remote control packaging as claimed in claim 1, wherein the two secondary segments (4) and (5) form the first of the walls and the middle segment (3) forms the second of the walls.

13. The remote control packaging as claimed in claim 1, wherein the foil inner layer fully encloses the interior of the packaging when the bag is closed.

14. Use of the remote control packaging as claimed in claim 1 for packaging a remote control.

15. Method for manufacturing a remote control packaging in the shape of a bag as claimed in claim 1, comprising at least the following steps:
a Providing the paper outer layer (9);
b Applying the foil inner layer (8) to form a multilayer, in particular two-layer, sheet (1) as a paper-plastic wall;
c Inserting rebated and/or folded lines (2) in the sheet (1) and/or
d shaping the packaging (10);
e Bonding the packaging (10) with shaping of the bag;
f Inserting the remote control into the packaging (10) and closing the insertion opening (13).
